(19) United States
(12) Patent Application Publication
(10) Pub. No.: US 2026/0369050 A1
(43) Pub. Date: Nov. 19, 2026

(54) MANAGING IMAGE ZOOM FOR MODEL PROCESSING

(71) Applicant: GOOGLE LLC, Mountain View, CA (US)

(72) Inventors: Achin Kulshrestha, Toronto (CA); Jilin Tu, San Jose, CA (US); Omar Estrada Diaz, Sacramento, CA (US); Aveek Purohit, Palo Alto, CA (US); Alistair Michael Muldal, London (GB); Ruihan Zhang, Sunnyvale, CA (US); Benedict Odai, Mountain View, CA (US)

(21) Appl. No.: 19/678,858

(22) Filed: May 15, 2026

Related U.S. Application Data
(60) Provisional application No. 63/808,449, filed on May 19, 2025.

(51) Int. Cl. G06V 10/94; G06F 3/01; G06V 20/62; G06F 40/58

(52) U.S. Cl. CPC G06V 10/945; G06F 3/013; G06V 20/62; G06F 40/58; G06V 2201/09

(57) ABSTRACT

According to at least one implementation, a method can include receiving a request and a first image associated with the request. The method can further include determining a portion of the first image related to the request and generating a request for a second image associated with the portion of the first image. The method can include receiving the second image, wherein the second image includes more detail than the portion of the first image. The method can further include determining a response based on the request and the second image.

### CROSS-REFERENCE TO RELATED APPLICATION

This application claims priority to U.S. Provisional Patent Application No. 63/808,449, filed on May 19, 2025, entitled “MANAGING IMAGE ZOOM FOR MODEL PROCESSING”, the disclosure of which is incorporated by reference herein in its entirety.

### BACKGROUND

Computing environments increasingly use virtual assistants or agents designed to facilitate user interactions with the physical world. These agents can act as intermediaries that process complex inputs and provide actionable information or assistance. For example, an agent may be configured to answer questions, set reminders, or control applications based on commands received from a user. To understand the context of a user inquiry, such as “What does this sign say?” or “Identify this object,” these agents can leverage data from various sensors to perceive the user’s surroundings. These sensors may include outward-facing cameras, depth sensors, and motion trackers that provide a visual and spatial understanding of the local environment.

Wearable devices, such as smart glasses or augmented reality (AR) glasses, provide a platform for these agents by incorporating hardware components directly into a form factor worn by a user. These devices typically feature lightweight frames equipped with integrated cameras and transparent or semi-transparent displays. Unlike traditional mobile devices, wearable devices can capture a first-person perspective of the environment, aligning the camera’s field of view with the gaze of the user. This configuration enables a hands-free experience where the agent can observe the same physical objects and text that the user is viewing in real-time. By utilizing these wearable interfaces, an agent can provide seamless assistance that integrates digital information directly into the user’s perception of the physical world.

### SUMMARY

Systems and methods are provided for determining a response to a request based on visual context from images of varying detail. According to at least one implementation, a system may be configured to receive a request and a first image associated with the request. The first image may comprise a reduced-resolution version of an original image stored in a local buffer of a device, such as smart glasses or an augmented reality headset. The system can be configured to determine a portion of the first image relevant to the request, which may be based on the language cues in the request, gestures, the user’s gaze, or another factor. In some implementations, the determination of the portion occurs in response to determining that an initial response fails to satisfy at least one criterion, such as a confidence threshold, or determining that the first image satisfies a criterion related to a quantity of objects or challenging visual conditions.

The system can further be configured to generate a request for a second image associated with the portion of the first image and receive the second image from the device. The second image includes more detail, such as more pixels or a higher resolution, than the portion of the first image. In some implementations, the second image includes a subset of pixels from the original image stored in the local buffer. The system can then determine a response based on the request and the second image. This determination can optionally include determining text captured in the second image and determining the response based on the identified text. By using the higher resolution second image for targeted analysis, the system can resolve fine details that were ambiguous in the first image, thereby improving the accuracy of the response provided to the user.

In some aspects, the techniques described herein relate to a method including: receiving a request and a first image associated with the request; determining a portion of the first image related to the request; generating a request for a second image associated with the portion of the first image; receiving the second image, the second image including more detail than the portion of the first image; and determining a response based on the request and the second image.

In some aspects, the techniques described herein relate to a computer-readable storage medium having program instructions stored thereon that, when executed by at least one processor, direct the at least one processor to perform a method, the method including: receiving a request and a first image associated with the request; determining a portion of the first image related to the request; generating a request for a second image associated with the portion of the first image; receiving the second image, the second image including more detail than the portion of the first image; and determining a response based on the request and the second image.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: receiving a request and a first image associated with the request; determining a portion of the first image related to the request; generating a request for a second image associated with the portion of the first image; receiving the second image, the second image including more detail than the portion of the first image; and determining a response based on the request and the second image.

The accompanying drawings and the description below outline the details of one or more implementations. Other features will be apparent from the description, drawings, and claims.

### BRIEF DESCRIPTION OF THE DRAWINGS

FIG. 1 illustrates a computing environment for selecting image portions for processing by a model according to an implementation.

FIG. 2 illustrates a method of providing a result to a request based on image zoom according to an implementation.

FIG. 3 illustrates an operational scenario of identifying a relevant portion of an image for model processing according to an implementation.

FIG. 4 illustrates an operational scenario of identifying a relevant portion of an image for model processing according to an implementation.

FIG. 5 illustrates an operational scenario of identifying a relevant portion of an image for model processing according to an implementation.

FIG. 6 illustrates an operational scenario of generating a response without requesting additional image context according to an implementation.

FIG. 7 illustrates a computing system for selecting image portions for model processing according to an implementation.

### DETAILED DESCRIPTION

The present disclosure relates to systems and methods for receiving a request and a first image associated with the request and determining a response based on a higher-resolution second image. In some implementations, the first image may be captured by an outward-facing camera of a wearable device, such as smart glasses or an augmented reality headset, to provide visual context for a user request. For example, a user wearing smart glasses may provide a request such as “What does this sign say?” or “Identify this object.” The first image may comprise a reduced-resolution version of an original image (e.g., a full-resolution frame stored in a local buffer on the wearable device), which facilitates rapid communication to a server while minimizing power consumption. As used herein, reduced-resolution refers to an image state wherein the total pixel count is lower than the original captured frame, specifically configured to meet a bandwidth or power consumption constraint of a mobile or wearable device. The server can be responsible for processing the request and the first image using at least one machine learning model to determine a portion of the image relevant to the request or to identify when additional visual detail is required to generate an accurate response. In some implementations, a processing system (i.e., at the server or cloud computing system) can determine a portion of the first image related to the request by identifying an object referenced in the request or by determining that an initially generated response (i.e., from the model) fails to satisfy at least one criterion, such as a confidence threshold. A confidence threshold can be a predefined numerical value representing a minimum probability, generated by a machine learning model, that a predicted output or response accurately corresponds to the user request. The system may then generate a request for a second image associated with the portion of the first image, where the second image includes more detail, such as more pixels or a higher resolution, than the corresponding portion of the first image. In some implementations, the second image includes a subset of pixels from the original image stored on the wearable device. Upon receiving the second image, the system can determine a response, which may optionally involve determining text captured in the second image to satisfy the user request.

For example, the system may be utilized by a user trying to determine the opening date of a movie from an advertisement, such as a poster in a physical environment. The user may provide a request comprising “When does this movie open?” while wearing a wearable device. The wearable device captures a first image of the environment at a first resolution and communicates the request and the first image to a server. In some examples, the first image may comprise a reduced-resolution version of an original image, which can be derived by downsampling or otherwise reducing the pixel count of a full-resolution frame stored in a local buffer of the wearable device. Reducing the resolution in this manner facilitates rapid communication to a server while minimizing power consumption and bandwidth usage during the initial processing of the request. To determine a response, the system first determines a portion of the first image related to the request. In this instance, at least one machine learning model processes the request and the visual context of the advertisement to identify an object referenced in the request, such as a region of interest containing the movie title or fine print. The model determines that an additional higher-resolution image is required by evaluating whether an initial response fails to satisfy at least one criterion, such as a confidence threshold. For example, if the first image is motion-blurred or the text is too small to be accurately read at the reduced resolution, the system generates a request for a second image associated with the portion. The wearable device then retrieves a higher-resolution version of that specific portion from a local buffer and provides the second image to the server, enabling the system to determine text captured in the second image to satisfy the user request.

In another example, a different user request may include a user pointing toward a shelf in a store and asking, “What are the ingredients in this snack?” The system receives the request and a first image captured by the outward-facing camera. The model determines which portion of the first image is relevant by identifying an object referenced in the request, specifically the snack packaging, and determining the portion of the first image associated with that object. The model may determine that a higher-resolution image is required based on the low-res view, suggesting challenging conditions, such as dense text on an ingredient list that cannot be resolved in the first image. In some implementations, the system may determine that the portion of the first image related to the request is a full frame (i.e., the entire original image), and the model may therefore request a higher-resolution version of the full image rather than a smaller portion. Once the second image is received, providing more detail than the corresponding portion of the first image, the system processes the additional detail to identify the specific ingredients and to determine a response based on the request and the second image. For example, in response to a request such as “What are the ingredients in this snack?”, the system may identify specific allergens, nutritional components, or a full list of ingredients found on the packaging. To generate this response from the second image, the system processes the higher-resolution visual data to resolve fine details, such as small-print text on a label, that were illegible in the first image. The model identifies the relevant text within the second image and may optionally perform a web search based on the identified text, product names, or logos to retrieve additional context or verify the ingredient information. The response can then be provided to the wearable device for the user.

In computing, wearable devices, such as smart glasses or augmented reality (AR) headsets, provide a hands-free platform for conversational AI agents to interact with a user’s surroundings. These agents can perform various tasks for the user, such as identifying physical objects, translating text in real-time, or providing contextual information based on a first-person perspective. However, several technical problems are associated with providing an accurate response for the user in these computing environments. For instance, outward-facing cameras on wearable devices often stream low-resolution or motion-blurred imagery to conserve power and minimize bandwidth. This lack of visual clarity can lead to inaccuracies or false determinations by the machine learning models, especially when the user request requires fine detail, such as reading small print on an ingredient list or identifying a specific product in a cluttered scene. Furthermore, complex lighting conditions and field-of-view mismatches between sensors can make it difficult for an agent to isolate the relevant portion of an image needed to satisfy a query. These technical problems can result in a poor user experience where the AI agent fails to reach a sufficient confidence threshold to provide a reliable response.

In some technical solutions, a wearable device may receive a request or query from a user through various integrated input components designed for hands-free interaction. In some implementations, the device may include one or more microphones configured to capture voice input or speech commands from the user. These microphones can be part of an audio subsystem that may utilize beamforming or noise-cancellation technologies to isolate the user’s voice from environmental noise. Additionally, a request may be received via gesture-based inputs captured by sensors, such as an inertial measurement unit (IMU) including accelerometers and gyroscopes to detect head movements, or via touch-sensitive surfaces located on a frame or temple of the device. In some instances, a query may be initiated passively based on a state of the device, such as a translation mode that triggers an automated request for information whenever specific visual patterns are detected in the user’s environment.

The hardware architecture of the wearable device can incorporate a variety of perception and processing technologies to facilitate these interactions. This may include outward-facing cameras, depth sensors, and ambient light sensors co-located on a frame of the device. The device may further include eye trackers to determine a gaze of a user, enabling the system to understand the spatial context of a request like “What is that object?” To handle the high-resolution data required for detailed visual tasks, the wearable device may feature a local buffer or memory store. This buffer can be configured to temporarily hold a short duration of recent high-resolution frames, allowing the processing system to retrieve original, full-quality image data even if a lower-resolution version was used for initial contextual sensing.

To capture an image, the outward-facing camera receives light through a lens and converts it into digital data based on current camera parameters, such as exposure and gain settings. In some implementations, the camera may be oriented to align with a field-of-view of the user, capturing a first-person perspective of the physical environment. When a request is initiated, the device may capture an original image at a high resolution (e.g., 3840 x 2160 pixels). This original image can be held in the local buffer as a full-resolution frame. The device may also generate a first image, which may comprise a reduced-resolution version of the original image, derived through downsampling or by decreasing the pixel count, to facilitate rapid internal processing or minimize power consumption. This ensures that the system retains access to the fine details of the original image for tasks requiring high visual clarity, such as reading small print or identifying distant landmarks, while initially operating with a more efficient, lower-resolution context.

In some implementations, a request and a first image are communicated from a wearable device to a server-side or cloud computing system to initiate the determination of a response. The request may be identified from various user inputs, such as a voice command captured by a microphone, a gesture detected by motion sensors, or a selection made via a touch-sensitive interface. To provide visual context for this request, the device may capture an original image using an outward-facing camera. Typically, the original image is captured at a high resolution upon request initiation and temporarily stored in a local buffer on the wearable device. The device then generates a first image, which may comprise a reduced-resolution version of the original image, and transmits both the request and the first image to the server-side system. For example, when a user asks, “What kind of plant is this?”, the wearable device captures a full-resolution original image at that moment, saves it to a buffer, and then communicates the spoken request along with a downsampled, lower-resolution first image to the cloud for initial processing. In another example, a device operating in a passive translation mode may automatically identify a request when the camera detects a sign in the environment. The device then captures an original high-resolution frame of the sign and provides a lower-resolution first image to the server to determine if a more detailed view is necessary for translation.

When the request and the first image are received, the server-side system or cloud computing system, which may comprise one or more computing devices, can be configured to determine a portion of the first image related to the request. In some implementations, to determine a portion of the first image related to the request, the system may be configured to identify one or more objects, regions of interest, or visual patterns referenced in the request. In some implementations, the relevant portion is identified by first determining an initial response or prediction based on the low-resolution first image, and then evaluating whether the response satisfies at least one criterion, such as a confidence threshold. If satisfied, the initial response can be provided without requesting additional visual context (i.e., a higher-resolution portion of the original image). However, when the confidence threshold is not satisfied, the system can determine the portion for additional analysis. Factors used to identify the relevant portion may include a gaze associated with a user’s gaze, a detected gesture, spatial coordinates derived from sensors, or natural language cues in the request, such as “this sign” or “that object.” For example, if a user asks for a translation of a specific notice on a cluttered wall, the system may utilize eye-tracking data or a region-of-interest prediction to isolate the specific text block from the broader environment.

When the request can be resolved using the first image, for instance, if the first image provides sufficient visual context and clarity to generate a response that satisfies a confidence threshold, the system may provide the response without requesting additional image data. This may occur in scenarios with optimal lighting or when the request involves large, high-contrast objects that are legible even at a reduced resolution. In such cases, the system can bypass the higher-resolution retrieval process to conserve power and minimize latency, directly communicating the determined information to the wearable device for presentation to the user.

In some implementations, the determination of the relevant portion is performed by at least one model, such as a machine learning model or a visual language model (VLM). The model may operate by processing the first image and the request to predict a region of interest (ROI) that contains the visual detail required to satisfy the query. This model can be configured (i.e., trained) using supervised learning on paired datasets comprising user requests and the corresponding relevant portions of images. During configuration, the model learns to identify patterns in user requests and map them to visual characteristics, effectively associating specific terminology with corresponding spatial regions in an image.

The inputs to the model can comprise the request (e.g., speech data, text, or a passive mode trigger) and the first image, which may optionally include additional sensor metadata such as gaze or depth information. The model provides an output that identifies a specific portion of the first image required for further analysis. This output is generally not the final response provided to the user, but rather the required portion of the first image that is needed at a higher resolution. For example, the output may comprise a set of coordinates, a timestamp, or a portion identifier that directs the wearable device to retrieve and provide a second, higher-resolution image from a local buffer to enable more accurate object recognition or text extraction.

As an illustrative example, the system may identify the relevant portion of the first image based on a gaze of a user. In an operational scenario where a user is wearing smart glasses in a museum, the user may look at a specific painting among a gallery of artworks and ask, “Who painted this?” The eye trackers in the wearable device detect the user’s gaze and provide spatial coordinates associated with the request. The model processes the first image along with the gaze data to determine that the portion of the image corresponding to the user’s focal point is the relevant region of interest. By isolating this specific portion based on the gaze, the system can request a high-resolution version of that painting alone, ensuring the model has sufficient detail to identify the artist while ignoring other paintings in the broader field of view.

In another example, the system may determine the portion related to the request by evaluating the visual quality of the first image or the confidence of an initial prediction. If a user captures an image of a menu and asks, “Does this have nuts?”, the model may identify that the text in the first image is motion-blurred or that the overall image lacks sufficient resolution to distinguish small-print ingredients. Based on the detected blurriness of the text or a low confidence score generated during an initial processing attempt, the system identifies the text block as the portion requiring additional detail. Similarly, if a first image is generally blurry due to device movement, the model may determine that a full-frame second image is required to satisfy the request. By identifying these portions based on factors such as blurriness or a failure to satisfy a confidence threshold, the system ensures that a second, higher-resolution image is retrieved to provide an accurate and reliable response.

In some implementations, the server-side system can be configured to first determine whether the initial request and the first image can generate an initial response that satisfies at least one confidence criterion. If the initial response satisfies the at least one criterion, the initial response can be provided back to the user device without additional processing. However, if the initial response does not satisfy the at least one criterion, the system can identify a portion of the first image that can provide additional context associated with the request.

When it is determined that additional context is required, the system can be configured to generate the request for the second image by identifying one or more parameters that define the required visual data for the wearable device. In some implementations, the request indicates to the user device what portion is needed by providing a relevant portion identifier, such as a set of spatial coordinates (e.g., X and Y values) that define a bounding box or a specific set of pixels within the first-resolution image. This identifier can further include a timestamp to ensure the wearable device retrieves the correct high-resolution frame from a local buffer, such as a three-to-five-second sliding window of recent captures. By providing these targeted coordinates, the system directs the wearable device to perform a client-side crop of the original high-resolution data, which minimizes the amount of data transmitted back to the server while ensuring the machine learning model receives the necessary detail to resolve the request.

The size and scale of the portion identified in the request can be dynamic, adapting to the specific nature of the user’s inquiry or the characteristics of the detected objects. For example, the system may request a small, narrow portion to resolve fine print on a label, or a larger, wider portion to capture the full extent of a landmark or architectural feature. In some implementations, the request can specify multiple portions of the same image, such as when a user asks to compare two different products on a shelf. Furthermore, if the system determines that the relevant context is distributed across the entire field of view or if the initial region of interest is unclear, the request can be for the whole first image at a higher resolution rather than a subportion. This flexibility allows the system to balance data efficiency with the visual clarity required to satisfy the confidence threshold of the response model.

When the request is received by the device, the wearable device can be configured to process the targeted request by accessing the local buffer to retrieve the original high-resolution data. In some implementations, the wearable device maintains a short duration of recent high-resolution frames, such as a three-to-five-second sliding window, in the local buffer or memory store. Upon receiving the request for the second image, which may include a timestamp and a relevant portion identifier, the device identifies the specific frame matching the requested time. The device can then perform a client-side crop of the full-resolution frame based on the coordinates or bounding box defined by the relevant portion identifier. This targeted cropping allows the device to isolate the specific region of interest, such as a text block or a specific object, while minimizing the total amount of data transmitted back to the server.

The wearable device provides the second image to the server-side system, where the second image includes more detail, such as more pixels or a higher resolution, than the corresponding portion of the first image. In some implementations, the second image may comprise a subset of pixels from the original high-resolution frame stored in the buffer. By processing the original image to provide a smaller, higher-resolution second image, the device facilitates a more efficient use of bandwidth and power compared to streaming continuous high-resolution video.

Once the server receives this detailed visual data, the system can perform operations to process the additional visual detail and provide an accurate response. Determining the response based on the request and the second image can involve a high-resolution analysis phase where at least one model, such as VLM, can receive the low-resolution first image as context and/or the targeted high-resolution second image as a primary data source. In some implementations, the system may be configured to fuse these inputs, using the broad context of the first image to maintain spatial awareness and the high-resolution data of the second image to resolve fine details that were previously illegible or ambiguous. In some implementations, the model can use the second image exclusively for generating a response in association with the input.

To determine a response, the system may process the second image to identify text, objects, or patterns that were not discernible in the first image. For example, the model can perform text extraction (e.g., optical character recognition) on a high-resolution crop of a product label to identify specific ingredients, nutritional facts, or brand names. In another example, the system can perform object recognition on a high-resolution portion of a scene to distinguish between similar-looking items or to identify specific landmarks in a cluttered environment. In some implementations, the system may optionally perform one or more external actions, such as a web search or a database query, based on the data identified in the second image to retrieve supplementary information. This supplementary information, combined with the visual data, can then be processed by the model to generate a natural language response that satisfies the user’s inquiry.

The model used to determine the response can be configured (i.e., trained) using supervised learning on datasets that include paired examples of user requests and multi-resolution visual data. During configuration, the model learns to map specific terminology in a user request to corresponding visual characteristics in the imagery. For instance, the model may be trained to recognize that a request for “fine print” or “ingredients” requires identifying and processing high-frequency spatial features in high-resolution crops. This training enables the model to effectively interpret and respond to complex queries by prioritizing the detailed information captured in the second image while utilizing the first image for general environmental context.

As used herein, technical definitions within this process may include the VLM being characterized as a multi-modal machine learning architecture capable of processing both textual and visual inputs to generate a unified output. The resolution of the second image may be defined by a higher pixel density or a greater number of total pixels than the corresponding region in the first image, enabling the model to achieve a higher confidence score during the response determination phase. By utilizing this multi-step processing approach, the system minimizes false determinations and provides a reliable response that satisfies the user’s request with a high degree of accuracy.

In some implementations, even with the second image, the system (e.g., a cloud- or server-based system) may be unable to resolve the request or query. For example, the at least one machine learning model may determine that the second image, despite having a higher resolution or more pixels than the portion of the first image, remains insufficient to generate a response that satisfies at least one confidence threshold. This lack of confidence can occur due to extreme environmental factors such as severe motion blur, total occlusion of the object of interest, or lighting conditions that exceed the dynamic range of the camera sensor.

In these examples, the system may provide a response to the user indicating a lack of confidence or an inability to resolve the request. For example, the system may communicate an error message to the wearable device for audible or visual presentation, such as “I’m sorry, I can’t see that clearly enough to help” or “The image is too blurry to identify the object.” Furthermore, the system can be configured to provide suggestions for additional images or context to help resolve the request. These suggestions may include instructions for the user to change a physical orientation of the wearable device, such as “Please move closer to the sign,” “Try holding still for a moment,” or “Can you look at the object from a different angle?”

As an illustrative example, a user may ask, “What are the specific side effects listed on this medicine bottle?” The system receives a first image and identifies the label as the relevant portion. The system then requests and receives a second, higher-resolution image of the label. However, if the medicine bottle is cylindrical and a portion of the text is wrapped around the side and out of the field of view, the model may determine that the second image still does not contain enough information to provide an accurate and safe response. In this scenario, rather than artificially generating the missing text, the model may generate a response that identifies the limitation, such as: “I can see part of the label, but some of the text is cut off. Please rotate the bottle slowly so I can see the rest of the information.” This interactive feedback loop allows the system to guide the user in providing the necessary visual context to eventually satisfy the request.

As an example of the operations described herein, a user with smart glasses may view a specific painting among a gallery of artworks and provide a request such as “Who painted this?” The smart glasses capture a first image of the environment at a first resolution. This first image may be a reduced-resolution version of the original image, facilitating rapid communication with a server-side processing system while minimizing power consumption. The server-side processing system receives the request and the first image, then determines a portion of the first image relevant to the request. In some implementations, the system determines the portion by identifying an object referenced in the request, such as the painting, or by determining a gaze associated with the user. For instance, gaze-determination hardware in smart glasses can provide spatial coordinates, allowing the system to isolate the specific artwork the user is looking at. As another example, the system can isolate the artwork based on a user gesture that explicitly indicates the work that the user is referencing.

In some implementations, the system determines that a second image is required by evaluating whether an initial response fails to satisfy at least one criterion, such as a confidence threshold. For example, if the first image lacks sufficient visual clarity to resolve the artist’s signature or specific brushwork patterns, the system generates a request for a second image associated with the identified portion. This request may include a timestamp and a relevant portion identifier, such as spatial coordinates, directing the smart glasses to retrieve a more detailed version of that specific region from a local buffer. The smart glasses then provide the second image to the processing system, where the second image includes more detail than the corresponding portion of the first image.

As used herein, detail may be characterized as the quantity of visual information or data points available within a given area of an image. Technically, more detail can be defined by a higher pixel density, a greater total number of pixels, or a higher resolution than the corresponding region in the first image. For instance, the second image may comprise a subset of pixels from the original high-resolution frame stored in the local buffer of the smart glasses, whereas the first image represents a downsampled version. This increased detail enables the processing system to perform high-resolution analysis, such as identifying text captured in the second image or resolving fine patterns, to determine a response that satisfies the user’s request with a high degree of accuracy.

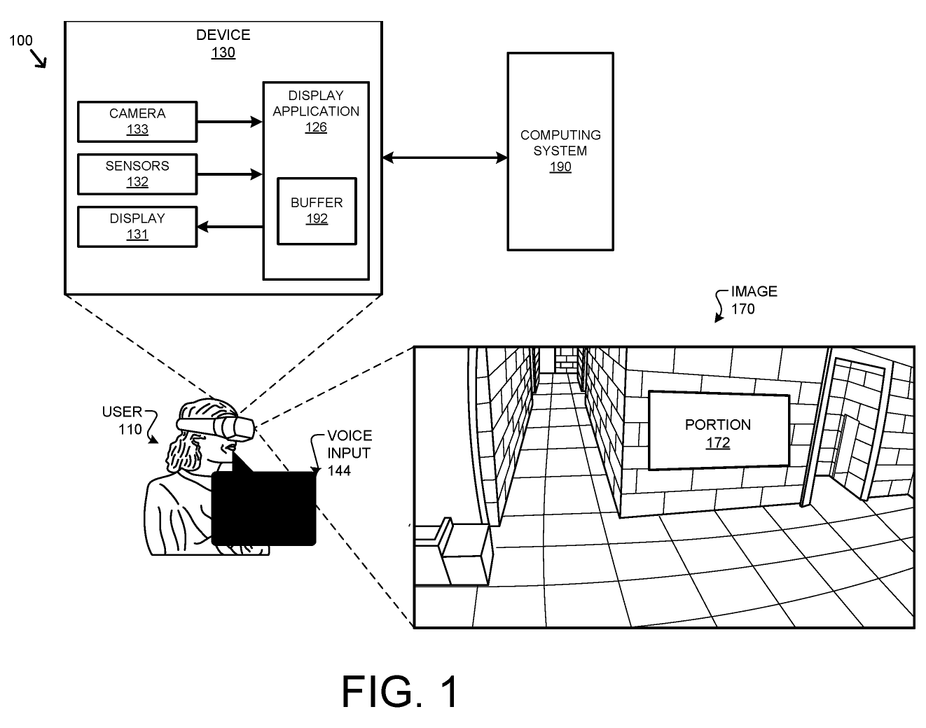

FIG. 1 illustrates a computing environment 100 for selecting image portions for processing by a model according to an implementation. Computing environment 100 includes user 110, device 130, voice input 144, and image 170. Device 130 includes display 131, sensors 132, camera 133, and response application 126. Device 130 is representative of a wearable device, such as smart glasses, an AR headset, an extended reality device, or other wearable devices. Image 170 represents an image captured by device 130 and includes portion 172 identified as relevant by computing system 190. Image 170 can be representative of a full-resolution image captured by camera 133, wherein image 170 can be reduced to a lower resolution and provided as a first image to computing system 190. Computing system 190 can include one or more computing devices (e.g., servers, desktops, companion devices, etc.). Although demonstrated as providing voice input 144 as the request, voice input is not required to implement the operations herein. Specifically, the device can generate responses based on images alone, text, speech, or other settings associated with the device. For example, in a translation mode, device 130 can capture images and translate text identified in the images using computing system 190. Computing system 190 can request higher-resolution portions of the images to read and translate text from the images as required. Thus, to translate a sign in a portion of a first image, computing system 190 can request an additional image associated with the portion, which provides a higher-resolution version.

In computing environment 100, the operation may be initiated when device 130 captures image 170 and receives a request, such as voice input 144 from user 110. Computing system 190 can receive the request and a first image associated with the request, where the first image may comprise a reduced-resolution version of an original high-resolution frame (e.g., image 170) held in local buffer 192 of device 130. A processing system on computing system 190, which can execute one or more machine learning models or visual language models, may determine portion 172 of the first image related to the request by identifying an object referenced in the request and/or by determining that an initial response fails to satisfy at least one criterion, such as a confidence threshold. Upon determining the relevant region (i.e., portion 172), computing system 190 can generate a request for a second image associated with portion 172. Device 130 may then retrieve the second image from the buffer 192 and provide it to the computing system 190, such that the second image includes more detail than the corresponding portion of the first image. The computing system 190 can then determine a response based on the request and the second image, which may optionally involve determining text captured in the second image to satisfy the user inquiry.

In some implementations, device 130 can be configured to manage the capture of the image 170 and the processing of a request, such as voice input 144 from user 110. Device 130 may include camera 133, which can be an outward-facing camera oriented to capture a first-person perspective of a physical environment. To provide visual context for voice input 144, camera 133 may capture image 170 at a high resolution, which can be held in local buffer 192 or a memory store. Device 130 can further include sensors 132, which may include microphones to capture voice input 144, eye trackers to determine a gaze of the user 110, or inertial measurement units (IMUs) to detect head movements. Response application 126 may be configured to direct the hardware components to communicate a first image, comprising a reduced-resolution version of image 170 and voice input 144 to computing system 190. Based on a determination that additional detail is required, response application 126 can receive a request for a second image corresponding to portion 172 of image 170. Response application 126 may then retrieve the second image from local buffer 192 and communicate it to computing system 190. Upon receiving a response from computing system 190, response application 126 can cause display 131 to present visual information related to the response to the user 110, such as by merging virtual elements with the physical world. In some implementations, the response can be provided to user 110 visually and/or audibly.

In some examples, computing system 190 can be configured to execute one or more machine learning models, such as a visual language model (VLM), to process a request and a first image associated with the request. When the first image and the request arrive at computing system 190, the system may first determine whether a response can be generated with just the first image. This determination can include evaluating whether an initially generated prediction satisfies at least one confidence threshold or criterion. If the request cannot be resolved using the first image alone, for instance, if the first image lacks sufficient resolution to distinguish fine details or text, the system determines a portion of the first image relevant to the request.

The one or more models work by identifying an object, region of interest, or visual pattern referenced in the request. In some implementations, the models are trained using supervised learning to map natural language cues, such as “this sign” or “that label,” to specific spatial coordinates or pixel regions within an image. The model may also utilize sensor metadata, such as eye-tracking data indicating a gaze of a user or depth information, to isolate the relevant portion. Once the second image is provided in association with the portion, providing a higher resolution or more pixels than the corresponding area of the first image, the system utilizes the additional visual detail to generate an accurate response. This may involve the one or more models performing text extraction, object recognition, or fusing the high-resolution data of the second image with the broad context of the first image to satisfy the user inquiry. In some implementations, the second model may also use external resources, such as reverse image search and/or web searches, to generate a response to the user request.

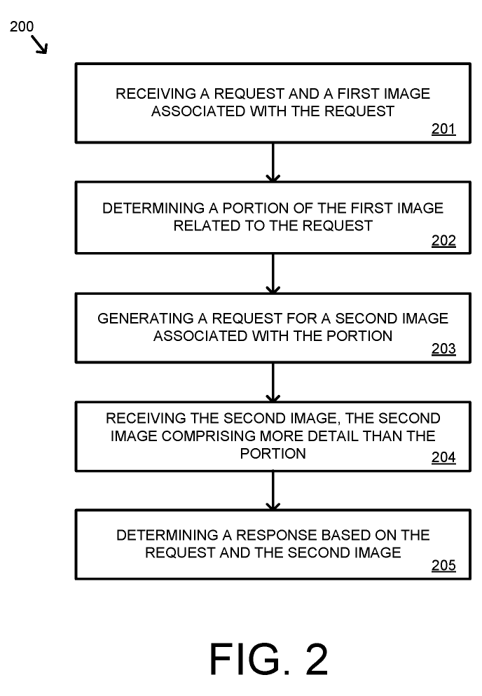

FIG. 2 illustrates method 200 of providing a result to a request based on image zoom according to an implementation. Method 200 can be performed by one or more computing devices, such as a server computing device or devices. The steps of method 200 are described below with reference to elements of computing environment 100 of FIG. 1.

Method 200 includes receiving a request and a first image associated with the request at step 201 and determining a portion of the first image related to the request at step 202. Method 200 further includes generating a request for a second image associated with the portion of the first image at step 203 and receiving the second image at step 204, wherein the second image includes more detail than the portion of the first image. Once received, method 200 further provides for determining a response based on the request and the second image at step 205.

As illustrated in method 200, at step 201, computing system 190 may receive a request and a first image associated with the request. The request may comprise voice input 144, such as “What does this sign say?”, or a passive trigger initiated by a mode of device 130. The first image may be captured by camera 133 and may comprise a reduced-resolution version of image 170. For example, device 130 may capture image 170 at a high resolution (e.g., 4K) and downsample the pixels to a lower resolution to facilitate rapid communication to computing system 190. This first image serves as an initial visual context, allowing one or more machine learning models to perform a preliminary analysis of the environment surrounding user 110. Receiving the request and the first image together enables the system to begin associating natural language cues with visual features while minimizing initial bandwidth consumption and power usage on device 130.

At step 202, computing system 190 determines a portion of the first image related to the request. This determination may be performed by at least one machine learning model, such as a VLM, which identifies an object referenced in the request or a region of interest (ROI) likely to contain the information needed to satisfy the request. In some implementations, identifying the portion comprises identifying an object referenced in the request and determining the portion of the first image associated with the object. For example, if voice input 144 specifies “the ingredients on this label,” the model may identify a specific rectangular region in the lower-resolution image corresponding to a product package. In some implementations, this step may further involve determining a gaze associated with user 110, wherein the portion is determined based on spatial coordinates where user 110 is looking. By isolating portion 172, the system focuses its computational resources and subsequent data requests on the most relevant visual data.

In some implementations, the one or more models can be configured (i.e., trained) to map natural language cues and visual patterns to specific spatial regions within an image. This configuration can include supervised learning on comprehensive datasets comprising paired examples of user requests and corresponding relevant portions of images. For instance, the dataset can include samples of low-resolution imagery and corresponding user queries (e.g., “What does this sign say?” or “Identify that object”), where each pair is labeled with a ground-truth region of interest (ROI) or bounding box that contains the visual information necessary to satisfy the query. During configuration, the model is configured to identify nonlinear relationships between specific terminology in a request and the spatial characteristics of the environment, enabling the system to predict which pixels are most relevant to the user’s intent.

In some examples, the model can be configured to process the request (e.g., text or speech data) and the first image as primary inputs. In some implementations, the inputs may further include additional sensor metadata, such as a user’s gaze or depth information, which the model uses to refine its prediction. To handle these disparate data types, the model may utilize a multi-branch architecture where a first branch extracts spatial features from the first image and a second branch processes the natural language of the request. These features are then fused to generate an output that identifies the specific portion of the first image required for higher-resolution analysis. For example, the model may be configured to recognize that a request for “fine print” or “ingredients” requires identifying high-frequency spatial features in the imagery, directing the system to request a second image of a specific text block. By training on diverse real-world scenarios, including cluttered scenes and varying lighting conditions, the model can accurately isolate the relevant portion even when a confidence threshold for an initial response is not satisfied.

At step 203, computing system 190 generates a request for a second image associated with the portion of the first image. This request is typically communicated from computing system 190 back to device 130. In some implementations, the request indicates to device 130 what portion is needed by providing a relevant portion identifier, such as a set of spatial coordinates or a bounding box. The request may further include a timestamp to ensure device 130 retrieves the correct frame from local buffer 192. Generating a targeted request for a specific portion, rather than the full high-resolution frame, allows the system to minimize the amount of data subsequently transmitted. This step may be triggered when the system determines that an initial response based on the first image fails to satisfy at least one criterion, such as a confidence threshold, or when the low-resolution view suggests challenging conditions like dense text.

In some implementations, generating the request for the second image occurs in response to determining that an initial response fails to satisfy at least one criterion. For instance, computing system 190 may first attempt to determine an initial response based on the request and the first image. If the text in the first image is too blurry or small to achieve a high confidence score, the system determines that the initial response is insufficient. Alternatively, as described in claim 6, determining the portion may occur in response to determining that the first image satisfies at least one criterion. This criterion may include a quantity of objects in the first image, such as a cluttered scene where the system identifies that high-resolution data is inherently necessary to distinguish between multiple similar items. Additionally, the at least one criterion may include environmental metrics or image characteristics, such as a determination that a spatial frequency of identified text exceeds a sampling threshold of the first resolution, or the presence of specific lighting artifacts. By evaluating these criteria, the system intelligently decides when the additional detail of a second image is required to ensure an accurate user experience.

At step 204, computing system 190 receives the second image, where the second image includes more detail than the portion of the first image. As used herein, more detail may be characterized as a higher pixel density or a greater number of total pixels within the spatial area defined by portion 172. Technically, the second image may include a subset of pixels from the original high-resolution additional image stored in local buffer 192 of device 130. For example, while the first image may have been downsampled to a 720p resolution, the second image may comprise a 1:1 pixel crop from a 4K sensor output. Receiving the second image provides the model with the visual clarity necessary to resolve fine patterns, small-print text, or distant objects that were illegible or ambiguous in the first image. This targeted retrieval of high-resolution data ensures that the most relevant portion of the scene is processed with precision.

As used herein, detail may be characterized as a quantification of the amount of visual information, information density, or data points available within a given area of an image. Technically, more detail can be defined by a higher pixel density, a greater total number of pixels, a higher resolution, an increased sampling rate, or a greater bit depth than the corresponding region in the first image. For instance, more detail can be associated with a higher spatial frequency that allows for the resolution of fine patterns or high-frequency features that are otherwise lost to aliasing or blurring in a lower-resolution context. The second image can include a subset of pixels from the original high-resolution frame stored in the local buffer of the device, whereas the first image represents a downsampled or compressed version. This increased detail enables the processing system to perform high-resolution analysis, such as identifying text captured in the second image or resolving intricate object characteristics, to determine a response that satisfies the request of the user with additional accuracy.

At step 205, computing system 190 determines a response based on the request and the second image. This operation can include a high-resolution analysis where at least one model processes the detailed visual data of the second image to generate a natural language answer or perform an action. In some implementations, determining the response comprises determining text captured in the second image and determining the response based on at least the text. For example, the system may perform optical character recognition (OCR) on the second image to read a restaurant’s name or a movie’s opening date. The model may also fuse the broad environmental context of the first image with the granular detail of the second image to maintain spatial awareness. By determining the response from the higher-quality data, the system achieves a higher confidence score and reduces the likelihood of inaccuracies.

In some implementations, the portion of the first image may comprise a full frame of the first image, particularly when the system determines that the relevant context is distributed across the entire field of view. In such cases, the second image comprises a resolution higher than the first resolution of the full first image. For example, if a user asks “What is in front of me?”, the model may determine that a high-resolution version of the entire scene is required to identify all relevant objects. The system then requests and receives a full-frame second image at the higher resolution. This flexibility allows the system to adapt the scale of the zoomed-in portion based on the specific nature of the user inquiry, ensuring that either a specific object or the entire environment can be resolved with high clarity when needed.

As an illustrative example, a user 110 wearing device 130 in a grocery store may point to a snack and ask, “Does this contain peanuts?” Computing system 190 receives this voice input 144 and a low-resolution first image. The model determines that portion 172 corresponding to the ingredient list is the relevant portion, but identifies that the text is too small to read at the current resolution. Computing system 190 then generates a request for a high-resolution second image of that specific text block. Device 130 retrieves the corresponding pixels from its local buffer and provides the second image to computing system 190. The system processes the second image to determine the text, identifies “peanuts” in the ingredient list, and generates a response such as, “Yes, this snack contains peanuts listed in the ingredients.” This multi-step process enables an accurate, detail-oriented response that would be impossible using only the initial low-resolution context.

In some implementations, computing system 190 may not require the second image to respond to the initial request. In some implementations, the system may be configured to determine a response based on the first image without requesting a second image. This may occur when a processing system determines that the first image provides sufficient visual context or clarity for one or more machine learning models to generate an initial response that satisfies at least one confidence criterion. For example, if a user asks a question about a large, high-contrast object in an environment with optimal lighting, the system may determine that the reduced-resolution of the first image is adequate for accurate object recognition or text extraction. In such scenarios, the system may bypass the generation of a request for a higher-resolution second image, thereby minimizing latency and reducing the power consumption associated with additional data transmission from device 130. By evaluating whether the initial processing satisfies a threshold, the system intelligently balances the need for visual detail with computational efficiency.

The confidence score associated with the response can be technically defined as a numerical value or probability metric generated by a machine learning model, such as a visual language model, representing a predicted level of accuracy or certainty that a generated output satisfies a user request. This score may be derived from an analysis of the first image and the request, where the model evaluates the alignment between identified visual features and the linguistic intent of the request. A confidence threshold may comprise a predefined value that defines a minimum level of certainty required to provide a response to a user. If the calculated confidence score exceeds this threshold, the system may determine that the response is reliable and communicate the information to device 130 for presentation. Conversely, if the confidence score falls below the threshold, the system may determine that the visual data in the first image is insufficient, prompting the determination of a relevant portion and a subsequent request for a higher-resolution second image to increase the accuracy of the final response.

In some examples, the response that is provided to the user may comprise a visual response presented via a display and/or a speaker. In at least one implementation, computing system 190 can be configured to provide various types of responses based on a second image and a request of user 110. In some implementations, the response may identify one or more physical objects within an environment of user 110, such as a specific piece of artwork or a product on a shelf. The response can optionally include a translation of text captured in the second image, such as a real-time translation of a street sign or a notice. To facilitate a conversational experience, computing system 190 may generate a response comprising a natural language summary or provide contextual information associated with a query. In some implementations, computing system 190 may utilize at least one external source, such as a website, a database, or an external application, to retrieve supplementary data related to the request. For example, computing system 190 may perform a web search based on a logo or a product name identified in the second image to provide a link to a website or a digital menu.

As an illustrative example, if user 110 provides a request such as “What is this building?”, computing system 190 may process a higher-resolution second image to identify the building and provide a response including a summary of its history and current hours of operation retrieved from a web search. In another example, in response to a request such as “Translate this poster,” computing system 190 may extract text from a second image and provide a response that displays the translated text over the physical object via display 131. These responses can be provided as a combination of visual overlays, text, and audible speech to assist user 110 in interacting with the physical world.

As used herein, a response can be technically defined as a multi-modal output generated by a computing system or machine learning model (such as a visual language model) that satisfies a user query based on the extraction of features from visual data and the retrieval of supplementary information. In some implementations, the response can be used to characterize the second image, wherein characterizing the image includes processing its higher-resolution visual data to identify fine details, objects, or patterns that were not discernible in the first image. This detailed analysis can include performing object recognition to distinguish specific items or landmarks in a cluttered scene, extracting small-print text via optical character recognition (OCR) to read information like ingredients or names, and generating real-time translations of the captured text to provide an accurate, multi-modal response to the user. In some examples, the response can be configured to provide contextual information, natural language summaries, or interactive feedback to the user. Depending on the hardware of the wearable device, the response can be presented to the user as a combination of visual overlays, text, and audible speech via a transparent or semi-transparent display and/or a speaker.

The content included in the response can vary based on the specific user request and may seamlessly integrate digital information into the user’s perception of the physical world. For example, if a user provides a request such as “What is this building?”, the system can process a high-resolution image to identify the building, execute a query using an external source (e.g., a website or database), and generate a response that includes a natural language summary of the building's history and current hours of operation. In another example, if the user asks the system to “Translate this poster,” the response may comprise translated text that is visually overlaid directly over the physical object on the user’s display.

Furthermore, if the system determines that the visual data fails to meet a required confidence threshold due to environmental factors (e.g., extreme occlusion, lighting, or severe motion blur), the response may include a notification indicating that the request cannot be resolved. In this scenario, the response may include an audible or visual error message, such as “The image is too blurry to identify the object” or “I can see part of the label, but some of the text is cut off”. To facilitate an interactive feedback loop, this response can further include actionable suggestions that instruct the user to change their physical orientation, such as prompting the user to “move closer,” “hold still,” or rotate an obstructed object so the system can capture the necessary visual detail.

In some implementations, computing system 190 may determine that even the second image fails to provide sufficient clarity or information to generate a response that satisfies at least one confidence threshold. This may occur due to persistent environmental factors such as extreme occlusion, lighting conditions exceeding a dynamic range of camera 133, or severe motion blur that is present even in the high-resolution data held in local buffer 192. When such a failure to resolve the request occurs, computing system 190 can be configured to provide a response to user 110 through device 130 that indicates the limitation. For example, the response may include an audible or visual notification such as “The image is too blurry to identify the object” or “I am unable to see the text clearly.”

Additionally, computing system 190 can be configured to suggest one or more potential remedies or actions for user 110 to perform to resolve the ambiguity. These remedies may comprise instructions to change a physical state or orientation of device 130 or the surrounding environment. Suggestions can include “Please move closer,” “Try to hold still for a moment,” or “Provide more lighting.” In scenarios where an object is partially obscured or oriented away from camera 133, the one or more machine learning models may identify the obstruction and instruct user 110 to manipulate the object, such as by rotating a package to reveal hidden text or moving an obstructing item. By providing this interactive feedback, computing system 190 enables an iterative process to eventually capture the visual detail required to determine an accurate response.

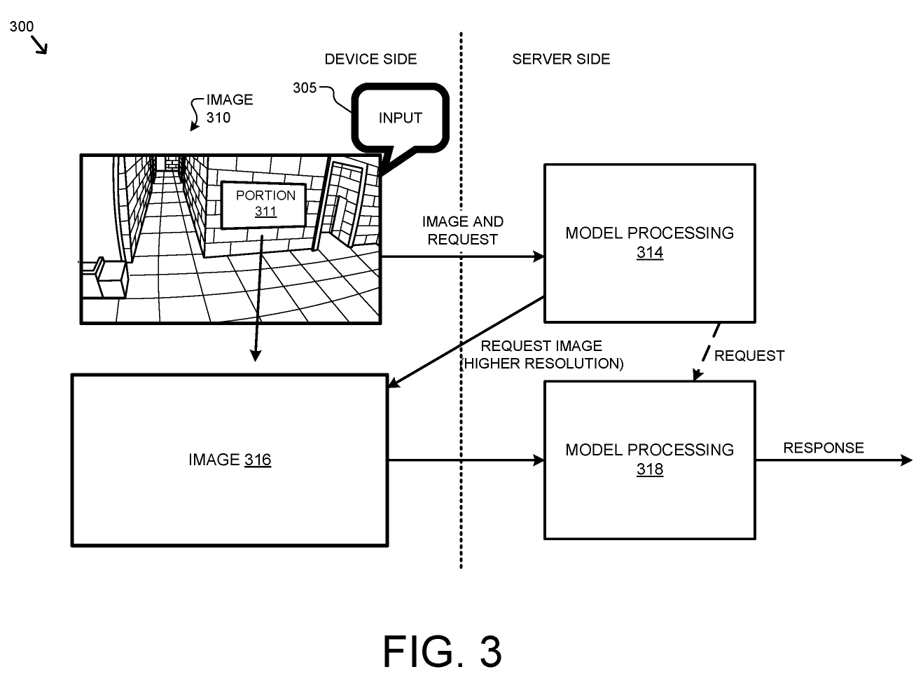

FIG. 3 illustrates an operational scenario 300 of identifying a relevant portion of an image for model processing according to an implementation. Operational scenario 300 includes input 305, image 310, portion 311, model processing 314, image 316, and model processing 318.

In operational scenario 300, a device, such as smart glasses or another head-worn device, identifies input 305 and corresponding image 310. Input 305 may comprise a voice request, such as a user asking for a translation or identification of an object, or may comprise a passive trigger associated with a state of the device (e.g., identifying a foreign language). Image 310 may be captured by an outward-facing camera and may comprise a reduced-resolution version of an original high-resolution frame held in a local buffer. Communicating a reduced-resolution version of image 310 and input 305 to a server-side facilitates rapid processing while minimizing the bandwidth and power consumption of the device.

Upon receiving image 310 and input 305, a processing system at the server side implements model processing 314. Model processing 314 can include one or more machine learning models, such as a VLM, configured to process the visual and textual context to identify portion 311 related to the request. In some implementations, the system determines portion 311 by predicting a region of interest that contains specific details required to satisfy input 305, such as a text block or a specific object. Model processing 314 may further determine that an additional higher-resolution image is required by evaluating whether an initial response fails to satisfy at least one criterion, such as a confidence threshold.

In some implementations, model processing 314 determines portion 311 by analyzing the spatial and linguistic context of input 305 and image 310. Model processing 314 may be configured to identify specific objects, regions of interest, or visual patterns referenced in the request. Various factors can be considered during this determination, including natural language cues within user input 305, such as “this sign” or “that object.” Additionally, model processing 314 can consider a gaze of a user or detected gestures captured by sensors 132 to further isolate a relevant area. Other factors may include spatial coordinates, depth information, or the detection of specific environmental markers like text blocks, logos, or product packaging. In some implementations, model processing 314 may identify portion 311 in response to determining that an initial response fails to satisfy a confidence threshold or by identifying challenging visual conditions, such as dense text or motion blur, within image 310.

Model processing 314 can be configured (i.e., trained) to identify portion 311 using supervised learning on datasets comprising paired examples of user requests and corresponding relevant portions of images. During configuration, model processing 314 learns to map specific terminology and sensor metadata to spatial characteristics within an image, effectively predicting a region of interest that contains the detail required to satisfy a query. The size of portion 311 can be determined dynamically based on the nature of input 305 or the characteristics of the identified object. For example, the system may determine a small, narrow size for portion 311 to resolve fine print on a label, or a larger, wider size to capture an entire landmark or architectural feature. In some implementations, if the relevant context is distributed across the environment, the size of portion 311 may be determined to comprise a full frame of image 310.

Once portion 311 is identified (e.g., a relevant poster on the wall of a room), the server side generates a request for image 316. This request can be communicated back to the device and may include a timestamp and a relevant portion identifier, such as spatial coordinates corresponding to portion 311. In response to the request, the device can access a local buffer to retrieve the original high-resolution data and perform a client-side crop to isolate the pixels associated with the requested portion. The device then provides image 316 to the server side, where image 316 includes more detail, such as a higher resolution or greater pixel density, than the corresponding portion 311 of the original first image 310.

The server side then utilizes image 316 through model processing 318 to generate a response for the user. Model processing 318 can involve a high-resolution analysis phase where at least one model processes the additional visual detail to resolve fine details that were previously illegible or ambiguous in image 310. For example, image 316 may provide the clarity needed to perform optical character recognition on small-print text or to distinguish between similar-looking objects in a cluttered environment. In some implementations, the system may fuse the broad environmental context of image 310 with the granular detail of image 316 to maintain spatial awareness while generating the response.

Determining the response based on image 316 can optionally involve performing external actions, such as a web search or a database query, based on the information identified in the higher-resolution data. For instance, model processing 318 may identify a specific logo or product name in image 316 and retrieve supplementary information from a website to satisfy input 305. The resulting information can be processed to generate a natural language response that is then communicated back to the device for presentation to the user. This iterative process ensures that the system provides a reliable and detailed response that satisfies the user’s intent with a high degree of accuracy.

While FIGS. 2 and 3 illustrate a scenario where a single portion of an image is identified, models can be configured to identify a plurality of portions within the first image. In some implementations, identifying a plurality of portions comprises determining multiple sets of spatial coordinates or bounding boxes that correspond to different regions of interest within the same frame of the first image. This can be technically defined as a multi-region-of-interest extraction process where at least one machine learning model predicts discrete coordinates for each object or area referenced in a request. Each identified portion may be associated with a unique relevant portion identifier, allowing the device to perform multiple client-side crops from a single original high-resolution frame held in a local buffer. As an illustrative example, a user may provide a request such as “Identify these three different artifacts” while viewing a museum display. In this scenario, the computing system identifies three distinct portions of the first image, each containing one of the artifacts, and generates a request for three corresponding second images. These second images, each providing more detail than the corresponding portions of the first image, are then processed by the models to identify each artifact and determine a response that addresses multiple objects in an image frame.

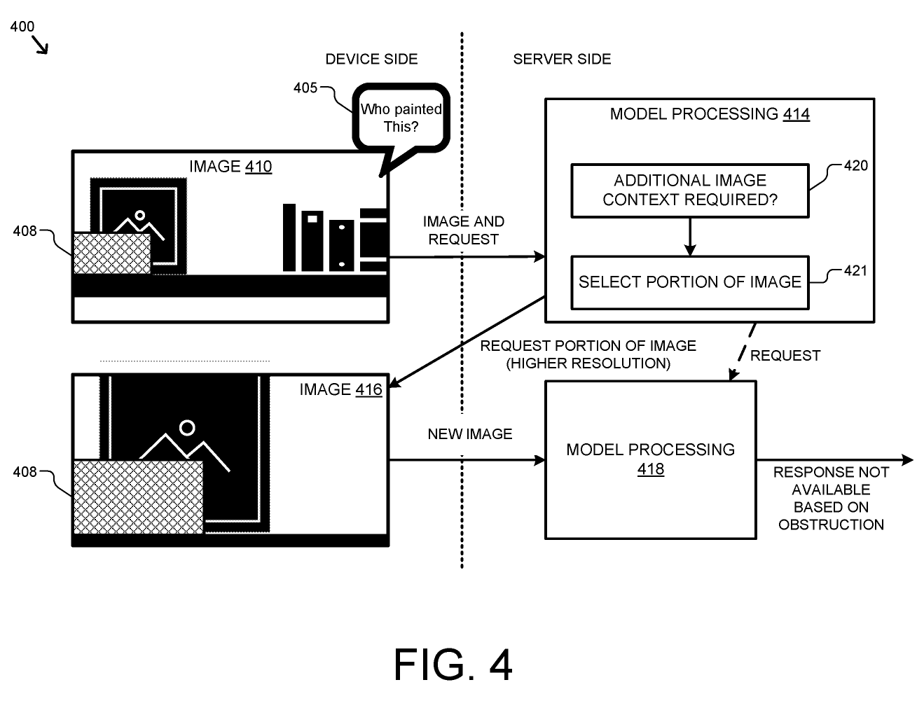

FIG. 4 illustrates an operational scenario 400 of identifying a relevant portion of an image for model processing according to an implementation. Operational scenario 400 includes request 405, image 410, model processing 414 with operations 420 and 421, image 416, obstruction 408, and model processing 418. Operational scenario 400 is representative of an example where the models are incapable of providing a response to request 405.

In operational scenario 400, a computing system receives request 405 and image 410 from a wearable device. Image 410 may comprise a reduced-resolution version of an original high-resolution frame held in a local buffer of the device to minimize initial data transmission. Model processing 414 is implemented to process request 405 and image 410 to determine if a response can be generated. Within model processing 414, operation 420 can be used to determine whether additional context is required to satisfy request 405, such as by evaluating whether an initial prediction based on image 410 fails to satisfy at least one confidence threshold. Operation 421 is used to select a portion of image 410 that is relevant to request 405, such as a specific region of interest containing text or an object.

Based on the determinations in operations 420 and 421, the computing system generates a request for image 416, which corresponds to the identified portion at a higher resolution. Upon receiving image 416, model processing 418 is implemented to determine a response based on request 405 and image 416. In operational scenario 400, obstruction 408 may be present within image 416, which can include environmental factors such as severe motion blur, occlusion of a target object, or extreme lighting conditions. Due to obstruction 408, model processing 418 may determine that the additional detail in image 416 remains insufficient to generate a response that satisfies at least one criterion. Consequently, the computing system may provide a response to a user indicating an inability to resolve request 405 or providing a suggestion for a user to capture an additional image, such as by moving closer to an object or changing a physical orientation of the wearable device.

For example, in operational scenario 400, a computing system may receive request 405 from a user viewing a gallery, where the user asks “Who is the artist of this painting?” Image 410 may capture a physical environment where a painting is at least partially obscured by a physical object, such as a radio. In this instance, model processing 414 implements operation 421 to identify the portion of the image related to the painting. However, due to obstruction 408 caused by the radio being positioned in front of a portion of the artwork, operation 420 may determine that the initial visual data is insufficient. The system then generates a request for image 416 to obtain a higher resolution view of the identified portion.

Upon receiving image 416, model processing 418 evaluates the additional image data. If obstruction 408 persists, for example, if the radio completely blocks the artist’s signature or critical stylistic details needed for identification, model processing 418 may determine that the request cannot be resolved with a sufficient confidence threshold. In such a case, the system may provide a response to the user via the wearable device indicating that the painting is obscured. The response may further include a suggestion for the user to change a physical orientation, such as “The painting is blocked by another object. Please move to the side so I can view the entire image or remove the object.”

As used herein, additional context may be characterized as supplementary visual data, such as more pixels or a higher resolution, required to increase a confidence score of a model. Technically, operation 421 may identify the portion by generating a relevant portion identifier comprising spatial coordinates that define a bounding box within image 410. Obstruction 408 may be defined as any visual interference that prevents a machine learning model from accurately extracting features required for object recognition or text analysis. By utilizing operations 420 and 421, the system can identify when even high-resolution data fails to resolve a query and guide a user to provide the necessary environment for a successful interaction.

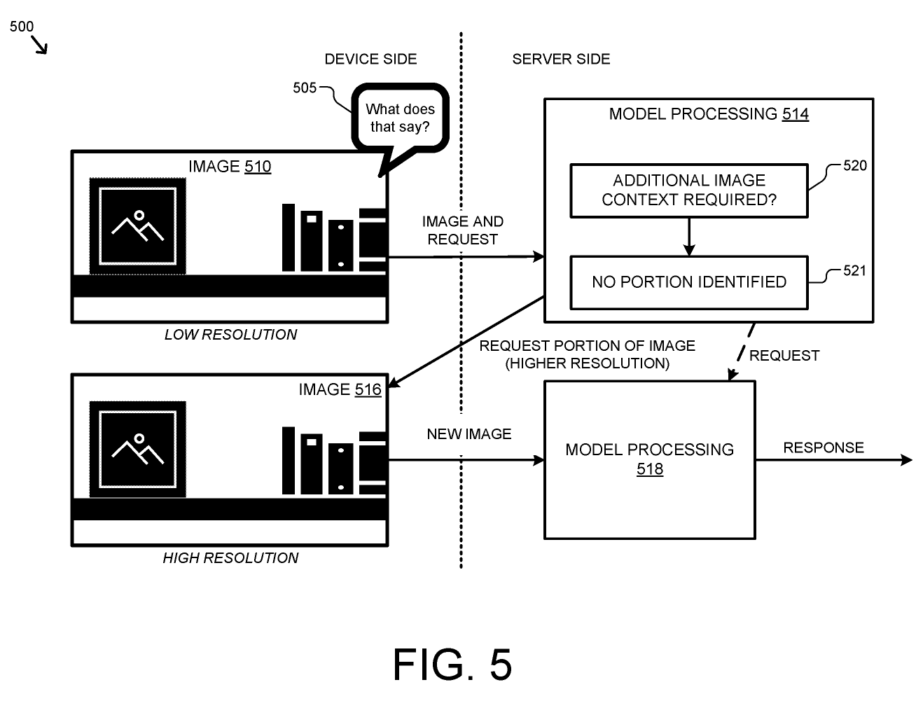

FIG. 5 illustrates an operational scenario 500 of identifying a relevant portion of an image for model processing according to an implementation. Operational scenario 500 includes request 505, image 510, model processing 514 with operations 520 and 521, image 516, and model processing 518. Operational scenario 500 provides an example where a smaller portion of image 510 cannot be identified as relevant to request 505, and the system instead requests a higher resolution of the full image.

In operational scenario 500, a computing system (i.e., server computing system or cloud computing system) can receive request 505 and image 510 from a device. Image 510 may comprise a first image at a reduced resolution used to provide initial context for request 505. Model processing 514 may be implemented to process request 505 and image 510, using operations 520 and 521 to determine whether additional visual data is required. Operation 520 can determine whether additional context is required by evaluating whether image 510 provides sufficient detail to respond to request 505. This determination may involve calculating a confidence score associated with an initial prediction. If the confidence score fails to satisfy at least one criterion, operation 520 may indicate that additional context is required.

Operation 521 can determine whether any specific portions of image 510 are available when additional context is required. Portions may satisfy criteria to be requested from the device if model processing 514 can identify a localized region of interest, such as a specific object or text block, referenced in request 505. In some implementations, model processing 514 may be configured to identify a portion based on a variety of data-driven parameters. For example, the criteria for identifying a portion may include identifying spatial coordinates associated with a gaze of a user, detecting a bounding box around a specific object, or isolating a region of interest based on linguistic cues in request 505. The model can be configured (i.e., trained) to recognize these regions by using supervised learning on datasets that pair various user requests with corresponding relevant image segments, enabling the model to learn the spatial relationships between natural language and visual features. Furthermore, a region may be required to satisfy a confidence threshold before being requested from the device. If the model determines that the probability of a specific portion containing the necessary detail falls below this threshold, the system may optionally bypass the targeted request or default to requesting a higher resolution of the full frame to ensure the technical goal of an accurate response is met.

In some instances, model processing 514 and operations 520 and 521 cannot identify a relevant portion or region of interest. This condition may occur when no specific sub-region within image 510 satisfies the criteria for a targeted request. When no portions satisfy the criteria, the system instead requests image 516, which comprises a full image with more detail, such as a higher-resolution version of the full frame of image 510. Requesting a full-frame higher-resolution image ensures that the model has the necessary clarity across the entire field of view to resolve request 505 when a specific localized region cannot be prioritized.

As an example, a user may provide request 505 comprising a request to “describe everything in this room” or “translate this entire page.” In this scenario, operation 521 may determine that no single portion satisfies the criteria because the relevant information is distributed across the full frame. In another example, if image 510 is generally blurry or low-contrast, operation 521 may be unable to identify a relevant portion with high confidence. In such cases, the system requests image 516 at a higher resolution to provide the detail required for model processing 518 to generate an accurate response. Once image 516 is received, model processing 518 analyzes the higher-resolution full frame to determine a response based on request 505.

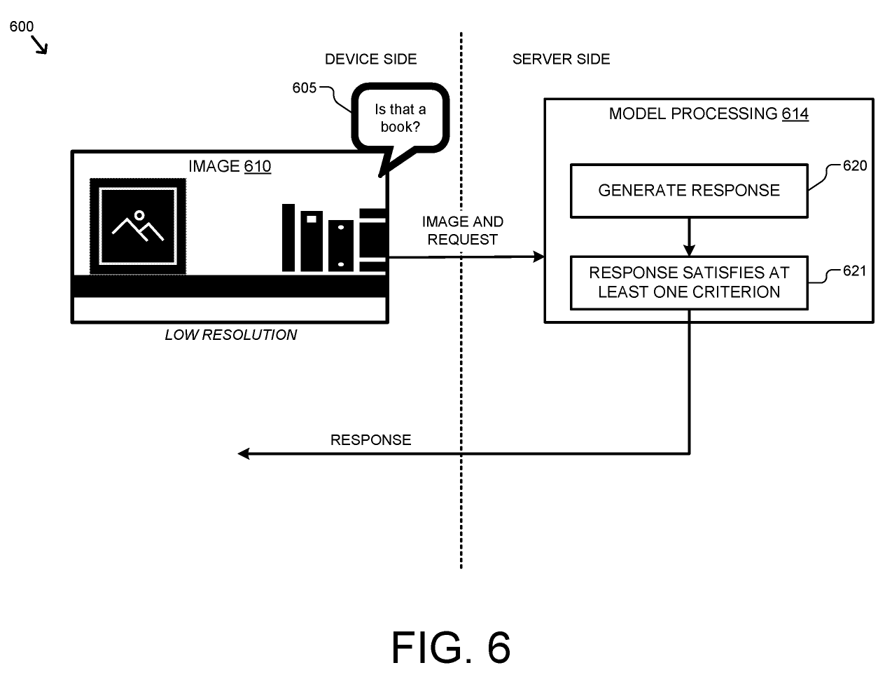

FIG. 6 illustrates an operational scenario 600 of generating a response without requesting additional image context according to an implementation. Operational scenario 600 includes request 605, image 610, and model processing 614 with operations 620 and 621.

In operational scenario 600, a computing system receives request 605 and image 610 from a device, such as smart glasses. Image 610 may comprise a first image at a reduced-resolution relative to an original high-resolution frame held in a local buffer of the device. Model processing 614 may be implemented to process request 605 and image 610, using operations 620 and 621 to determine whether a response can be generated without requesting additional context. Operation 620 can be configured to generate an initial response or prediction based on the first image 610 and the natural language cues in request 605. Operation 621 may be configured to evaluate the initial response against at least one criterion, such as a confidence threshold. A confidence score can be technically defined as a numerical value or probability metric generated by model processing 614 that represents a predicted level of accuracy or certainty that the initial response satisfies request 605. This score may be derived from an analysis of image 610 and request 605, where model processing 614/b> evaluates an alignment between identified visual features and linguistic intent. A confidence threshold can comprise a predefined value that defines a minimum level of certainty required to provide a response to a user. Model processing 614 can be configured to determine these values by comparing a calculated confidence score against the confidence threshold. If the calculated confidence score satisfies the confidence threshold, model processing 614 may determine that the initial response is reliable. Conversely, if the confidence score does not satisfy the confidence threshold, model processing 614 may identify that visual data in image 610 is 610 sufficient, which can trigger a determination of a relevant portion and a subsequent request for a higher-resolution second image to increase the accuracy of the final response.

If operation 621 determines that the initial response satisfies the at least one criterion, the computing system can provide the response to the device for presentation to a user without generating a request for a second, higher-resolution image. This operational flow allows the system to bypass the auto-zoom and retrieval process when the first image 610 provides sufficient visual clarity to resolve the user inquiry. By delivering the response directly, the system minimizes latency and reduces the power and bandwidth consumption required to transmit a second image.

For example, a user may provide request 605, such as “What color is this car?” while looking at a large, high-contrast vehicle in a well-lit environment. Although image 610 may be a reduced-resolution version of an original frame, the model processing 614 may determine that the color of the car is clearly discernible even at the lower resolution. In this instance, operation 621 determines that the confidence score for identifying the color satisfies the criterion for accuracy. Consequently, the system provides a response identifying the color without requesting a zoomed-in portion of the car. In another example, a user may ask, “Is there a sign on this wall?” while looking at a large, prominent billboard. Operation 621 may determine that the presence of the sign is identifiable with high confidence from the broad context of image 610, allowing the system to respond affirmatively and provide any available details without needing additional high-resolution context. This selective processing ensures that higher-resolution data is only retrieved when fine detail is technically required to satisfy the user’s intent.

In some implementations, the wearable device itself can perform the determination of the portion related to the request. For example, the wearable device can perform a first model to determine whether a response can be determined locally using the low-resolution version of the image. This local processing can minimize latency and reduce the need for constant cloud connectivity when simple visual queries are initiated. The wearable device can be configured to evaluate the complexity of the request or the clarity of the initial visual data to decide if additional processing power is required.

If the local model determines that higher-resolution data is necessary to satisfy the request, the device can then identify a specific portion of the image, such as a high-resolution crop, and communicate that portion to another computing system, such as a cloud computing system. This allows the cloud system to perform additional processing in association with the higher-resolution data, such as detailed object recognition or fine-print text extraction, without requiring the upload of a full high-resolution frame. By performing the initial determination of the relevant portion on the device, the system can further optimize bandwidth usage and power consumption while ensuring the machine learning models receive the necessary detail for an accurate response.

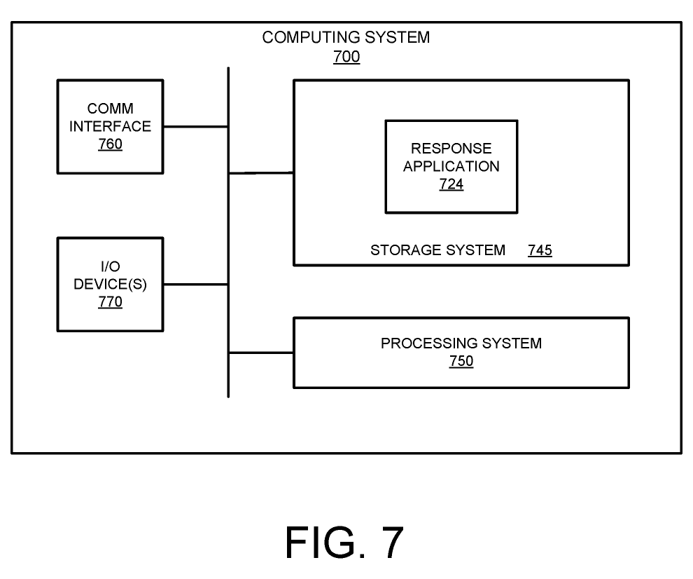

FIG. 7 illustrates a computing system 700 for selecting image portions for model processing according to an implementation. Computing system 700 is representative of any computing system or systems with which the various operational architectures, processes, scenarios, and sequences disclosed herein can be implemented to manage the generation of a response for a wearable device. Computing system 700 may include one or more computing devices, including server computing devices, desktop computing devices, companion devices for the wearable device (e.g., smartphone or tablet), and the like. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry, and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises response application 724. The operating software on storage system 745 may include an operating system, utilities, drivers, network interfaces, applications, or other types of software. When read and executed by processing system 750, the operating software on storage system 745 directs computing system 700 to operate as described in the previously described figures. Response application 724 can direct processing system 750 to perform at least method 200 of FIG. 2.

Below are example clauses associated with the present disclosure. The clauses described should not be considered exhaustive.

Clause 1. A method comprising: receiving a request and a first image associated with the request; determining a portion of the first image related to the request; generating a request for a second image associated with the portion of the first image; receiving the second image, the second image having more detail than the portion of the first image; and determining a response based on the request and the second image.

Clause 2. The method of clause 1, wherein the first image is a version of a third image that has a reduced resolution compared with the third image, and wherein the second image includes a subset of pixels from the third image.

Clause 3. The method of clause 1 further comprising: determining an initial response based on the request and the first image; and determining that the initial response fails to satisfy at least one criterion; wherein determining the portion of the first image related to the request occurs in response to determining that the initial response fails to satisfy the at least one criterion.

Clause 4. The method of clause 1, wherein determining the response based on the request and the second image comprises: determining text captured in the second image; and determining the response based on at least the text captured in the second image.

Clause 5. The method of clause 1, wherein determining the portion of the first image related to the request includes: identifying an object referenced in the request; and determining the portion of the first image associated with the object.

Clause 6. The method of clause 1 further comprising: determining that the first image satisfies at least one criterion; wherein determining the portion of the first image related to the request occurs in response to determining that the first image satisfies at least one criterion.

Clause 7. The method of clause 6, wherein the at least one criterion includes a quantity of objects in the first image.

Clause 8. The method of clause 1, wherein the portion of the first image includes a first resolution, and wherein the second image includes a second resolution.

Clause 9. The method of clause 1 further comprising: determining a gaze associated with a user for the request; wherein determining the portion of the first image related to the request comprises determining the portion of the first image related to the request based on the gaze.

Clause 10. The method of clause 1, wherein the first image comprises a first resolution, wherein the portion of the first image comprises a full frame of the first image, and wherein the second image comprises a second resolution higher than the first resolution.

Clause 11. A computer-readable storage medium having program instructions stored thereon that, when executed by at least one processor, direct the at least one processor to perform a method, the method comprising: receiving a request and a first image associated with the request; determining a portion of the first image related to the request; generating a request for a second image associated with the portion of the first image; receiving the second image, the second image having more detail than the portion of the first image; and determining a response based on the request and the second image.

Clause 12. The computer-readable storage medium of clause 11, wherein determining the response based on the request and the second image comprises: determining text captured in the second image; and determining the response based on at least the text captured in the second image.

Clause 13. The computer-readable storage medium of clause 11, wherein the first image is a version of a third image that has a reduced resolution compared with the third image, and wherein the second image includes a subset of pixels from the third image.

Clause 14. The computer-readable storage medium of clause 11, wherein determining the portion of the first image related to the request comprises: identifying an object referenced in the request; and determining the portion of the first image associated with the object.

Clause 15. The computer-readable storage medium of clause 11, wherein the method further comprises: determining an initial response based on the request and the first image; and determining that the initial response fails to satisfy at least one criterion; wherein determining the portion of the first image related to the request occurs in response to determining that the initial response fails to satisfy the at least one criterion.

Clause 16. The computer-readable storage medium of clause 11, wherein the method further comprises: determining that the first image satisfies at least one criterion; wherein determining the portion of the first image related to the request occurs in response to determining that the first image satisfies at least one criterion.

Clause 17. The computer-readable storage medium of clause 11, wherein the method further comprises: determining a gaze associated with a user for the request; wherein determining the portion of the first image related to the request comprises determining the portion of the first image related to the request based on the gaze.

Clause 18. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: receiving a request and a first image associated with the request; determining a portion of the first image related to the request; generating a request for a second image associated with the portion of the first image; receiving the second image, the second image having more detail than the portion of the first image; and determining a response based on the request and the second image.

Clause 19. The computing system of clause 18, wherein determining the response based on the request and the second image comprises: determining text captured in the second image; and determining the response based on at least the text captured in the second image.

Clause 20. The computing system of clause 18, wherein determining the portion of the first image related to the request comprises: identifying an object referenced in the request; and determining the portion of the first image associated with the object.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

It will be understood that, in the foregoing description, when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms “directly on”, “directly connected to”, or “directly” may not be used throughout the detailed description, elements that are shown as being directly on, directly connected, or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms “above” and “below” can, respectively, include vertically above and vertically below. In some implementations, the term “adjacent” can include laterally adjacent to or horizontally adjacent to.

What is claimed is:

1. A method comprising:
receiving a request and a first image associated with the request;
determining a portion of the first image related to the request;
generating a request for a second image associated with the portion of the first image;
receiving the second image, the second image having more detail than the portion of the first image; and
determining a response based on the request and the second image.

2. The method of claim 1, wherein the first image is a version of a third image that has a reduced resolution compared with the third image, and wherein the second image includes a subset of pixels from the third image.

3. The method of claim 1 further comprising:
determining an initial response based on the request and the first image; and
determining that the initial response fails to satisfy at least one criterion;
wherein determining the portion of the first image related to the request occurs in response to determining that the initial response fails to satisfy the at least one criterion.

4. The method of claim 1, wherein determining the response based on the request and the second image comprises:
determining text captured in the second image; and
determining the response based on at least the text captured in the second image.

5. The method of claim 1, wherein determining the portion of the first image related to the request includes:
identifying an object referenced in the request; and
determining the portion of the first image associated with the object.

6. The method of claim 1 further comprising:
determining that the first image satisfies at least one criterion;
wherein determining the portion of the first image related to the request occurs in response to determining that the first image satisfies at least one criterion.

7. The method of claim 6, wherein the at least one criterion includes a quantity of objects in the first image.

8. The method of claim 1, wherein the response is a response characterizing the second image.

9. The method of claim 1, wherein the response indicates at least one of an inability to resolve the request or a suggestion for capturing an additional image.

10. The method of claim 1, wherein the response includes a translation of text captured in the second image.

11. The method of claim 1, wherein the portion of the first image includes a first resolution, and wherein the second image includes a second resolution.

12. The method of claim 1 further comprising:
determining a gaze associated with a user for the request;
wherein determining the portion of the first image related to the request comprises determining the portion of the first image related to the request based on the gaze.

13. The method of claim 1, wherein the first image comprises a first resolution, wherein the portion of the first image comprises a full frame of the first image, and wherein the second image comprises a second resolution higher than the first resolution.

14. A computer-readable storage medium having program instructions stored thereon that, when executed by at least one processor, direct the at least one processor to perform a method, the method comprising:
receiving a request and a first image associated with the request;
determining a portion of the first image related to the request;
generating a request for a second image associated with the portion of the first image;
receiving the second image, the second image having more detail than the portion of the first image; and
determining a response based on the request and the second image.

15. The computer-readable storage medium of claim 14, wherein determining the response based on the request and the second image comprises:
determining text captured in the second image; and
determining the response based on at least the text captured in the second image.

16. The computer-readable storage medium of claim 14, wherein the first image is a version of a third image that has a reduced resolution compared with the third image, and wherein the second image includes a subset of pixels from the third image.

17. The computer-readable storage medium of claim 14, wherein determining the portion of the first image related to the request comprises:
identifying an object referenced in the request; and
determining the portion of the first image associated with the object.

18. The computer-readable storage medium of claim 14, wherein the method further comprises:
determining an initial response based on the request and the first image; and
determining that the initial response fails to satisfy at least one criterion;
wherein determining the portion of the first image related to the request occurs in response to determining that the initial response fails to satisfy the at least one criterion.

19. The computer-readable storage medium of claim 14, wherein the method further comprises:
determining that the first image satisfies at least one criterion;
wherein determining the portion of the first image related to the request occurs in response to determining that the first image satisfies at least one criterion.

20. The computer-readable storage medium of claim 14, wherein the method further comprises:
determining a gaze associated with a user for the request;
wherein determining the portion of the first image related to the request comprises determining the portion of the first image related to the request based on the gaze.

21. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
receiving a request and a first image associated with the request;
determining a portion of the first image related to the request;
generating a request for a second image associated with the portion of the first image;
receiving the second image, the second image having more detail than the portion of the first image; and
determining a response based on the request and the second image.

22. The computing system of claim 21, wherein determining the response based on the request and the second image comprises:
determining text captured in the second image; and
determining the response based on at least the text captured in the second image.

23. The computing system of claim 21, wherein determining the portion of the first image related to the request comprises:
identifying an object referenced in the request; and
determining the portion of the first image associated with the object.
